(19) United States
(12) Patent Application Publication
(10) Pub. No.: US 2025/0150157 A1
(43) Pub. Date: May 8, 2025

(54) AMPLIFY-AND-FORWARD RELAY MECHANISM ENABLED BY MULTI-LINK OPERATIONS IN A WIRELESS NETWORK

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR); Il-Gu LEE, Seoul (KR)

(73) Assignee: NEWRACOM, Inc., Irvine, CA (US)

(21) Appl. No.: 18/923,546

(22) Filed: Oct. 22, 2024

Related U.S. Application Data
(60) Provisional application No. 63/596,109, filed on Nov. 3, 2023.

(51) Int. Cl. H04B 7/155; H04W 76/14; H04W 88/04

(52) U.S. Cl. CPC H04B 7/15535; H04W 76/14; H04W 88/04

(57) ABSTRACT

An embodiment is method performed by a source node to transmit data that is to be relayed by a relay node to a destination node using a multi-link device (MLD) amplify-and-forward (AF) relay mechanism. The method includes transmitting a relay trigger frame to the relay node on a first link between the source node and the relay node to set up a second link between the relay node and the destination node, receiving a relay response frame from the relay node on the first link as a response to the relay trigger frame, transmitting a relay initiation frame to the relay node on the first link to start a relay operation period, and during the relay operation period, transmitting a data frame on the first link that is to be relayed by the relay node to the destination node on the second link using an AF relay mechanism.

### CROSS-REFERENCE TO RELATED APPLICATION

This application claims the benefit of U.S. Provisional Application No. 63/596,109, filed Nov. 3, 2023, titled “Amplify-and-forward relay enabled by multi-channel operation in beyond IEEE 802.11be”, which is hereby incorporated by reference.

### TECHNICAL FIELD

The present disclosure generally relates to wireless communications, and more specifically, relates to relaying data in a wireless network using an amplify-and-forward (AF) relay mechanism that is enabled by multi-channel operations.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

Relay operations are being considered as a way to increase the communication range and network coverage in future wireless networks (e.g., wireless networks that are to implement the beyond IEEE 802.11be wireless networking standard (e.g., IEEE 802.11bn)). Relay operations may involve a relay node relaying data transmitted by a source node to a destination node. Previous wireless networking standards have considered the use of a decode-and-forward (DF) relay mechanism for relay operations. With the DF relay mechanism, the relay node decodes, re-encodes, and forwards the signal received from the source node to the destination node. The DF relay mechanism significantly increases the latency of data delivery due to the relay node having to decode and re-encode the received signal before being able to forward the received signal to the destination node.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing decode-and-forward (DF) relay operations with a non-simultaneous transmit and receive (NSTR) multi-link device (MLD) relay node, according to some embodiments.

FIG. 11 is a diagram showing DF relay operations with a STR MLD relay node, according to some embodiments.

FIG. 12 is a diagram showing MLD amplify-and-forward (AF) relay operations with a STR MLD relay node, according to some embodiments.

FIG. 13 is a diagram showing the format and contents of a relay initiation frame, according to some embodiments.

FIG. 14 is a flowchart of a method for transmitting data that is to be relayed by a relay node to a destination node using a MLD AF relay mechanism, according to some embodiments.

FIG. 15 is a flowchart of a method for relaying data transmitted by a source node to a destination node using a MLD AF relay mechanism, according to some embodiments.

FIG. 16 is a flowchart of a method for receiving data transmitted by a source node that was relayed by a relay node using a MLD AF relay mechanism, according to some embodiments.

### DETAILED DESCRIPTION

The present disclosure generally relates to wireless communications, and more specifically, relates to relaying data in a wireless network using an amplify-and-forward (AF) relay mechanism that is enabled by multi-link operations.

As mentioned above, the decode-and-forward (DF) relay mechanism significantly increases the latency of data delivery due to the relay node having to decode and re-encode the received signal before being able to forward the received signal to the destination node. The present disclosure introduces an AF relay mechanism that is enabled by multi-link operations. Such AF relay mechanism may be referred to herein as a multi-link device (MLD) AF relay mechanism. With the MLD AF relay mechanism disclosed herein, a relay node that receives a signal from a source node on one link of a multi-link may amplify and retransmit the signal to the destination node on another link of the multi-link without having to decode and re-encode the signal, thereby allowing data to be delivered to the destination node with lower latency compared to the DF relay mechanism. New control frames and frame exchange sequences are described herein to enable MLD AF relay operations.

According to some embodiments, a source node transmits a first trigger frame to a relay node on a first link between the source node and the relay node to set up a second link between the relay node and the destination node. Responsive to receiving the first trigger frame on the first link, the relay node transmits a second relay trigger frame to the destination node on the second link between the relay node and the destination node. The first link and the second link may operate in different channels. Responsive to receiving the second relay trigger frame, the destination node transmits a first relay response frame to the relay node on the second link. Responsive to receiving the first relay response frame on the second link, the relay node transmits a second relay response frame to the source node on the first link to confirm to the source node that the relay node can act as a relay between the source node and the destination node. Responsive to receiving the second relay response frame on the first link, the source node transmits a relay initiation frame to the relay node on the first link to start a relay operation period. During the relay operation period, the source node transmits a data frame on the first link and the relay node relays this data frame to the destination node on the second link using an AF relay mechanism.

An AF relay mechanism is a relay mechanism in which a received signal is relayed by amplifying the signal and retransmitting the signal without having to decode and re-encode the signal. The MLD AF relay mechanism described herein is an AF relay mechanism that leverages multi-link operations. For example, with the MLD AF relay mechanism, the relay node may receive a signal on one link of a multi-link, frequency shift the signal to a different channel, amplify the signal, and retransmit the signal on another link of the multi-link.

The control frames and frame exchange sequences described herein may allow for proper functioning of MLD AF relay operations. The use of MLD AF relay operations may increase the communication range and network coverage without significantly increasing the data delivery latency (compared to non-relay operations).

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

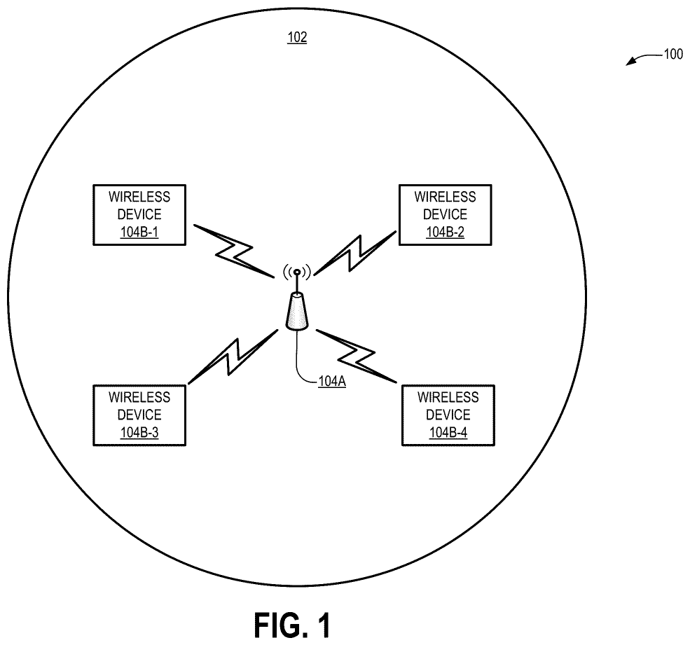

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

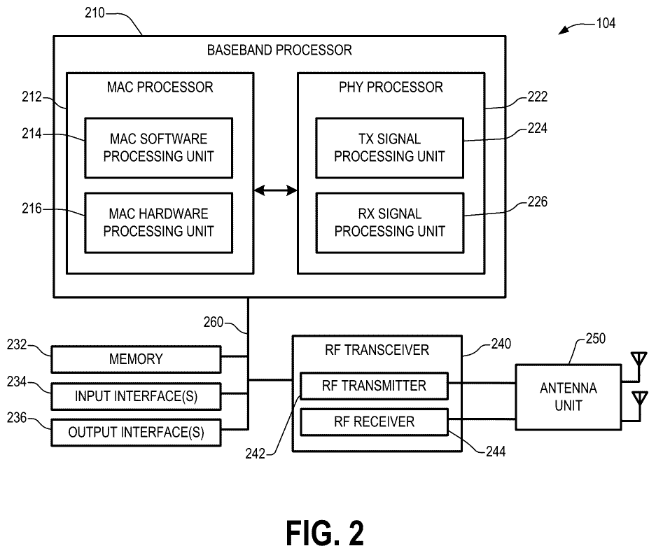

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

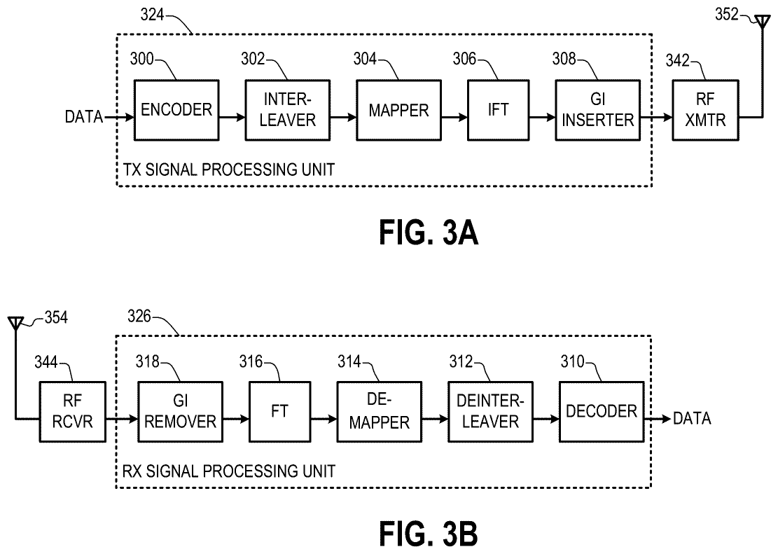

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

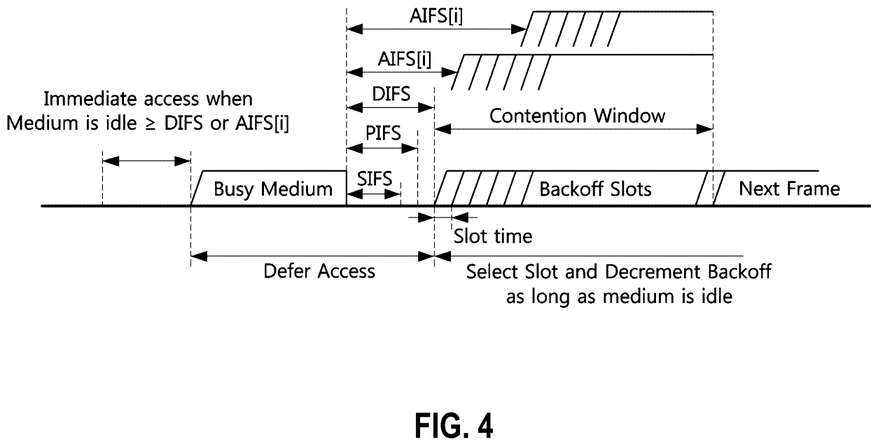

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

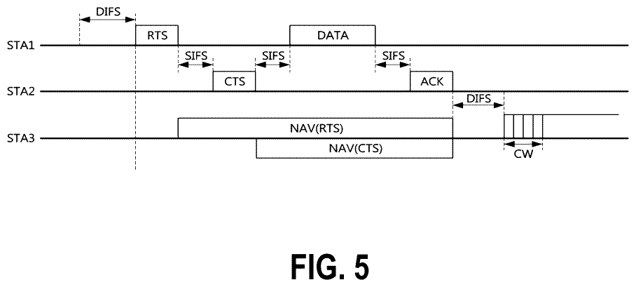

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

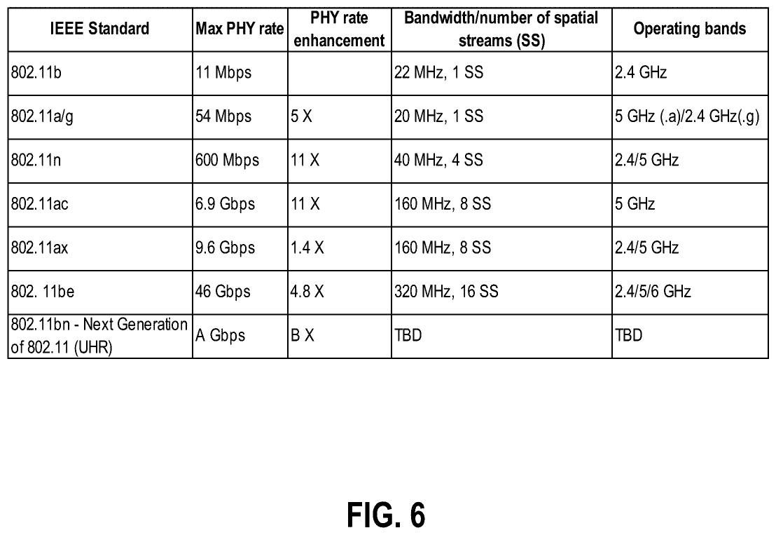

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

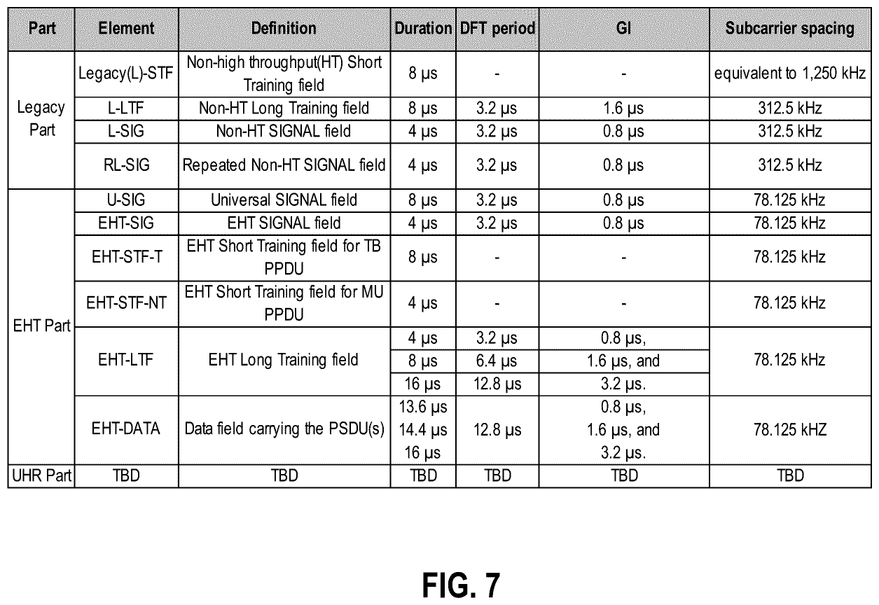

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

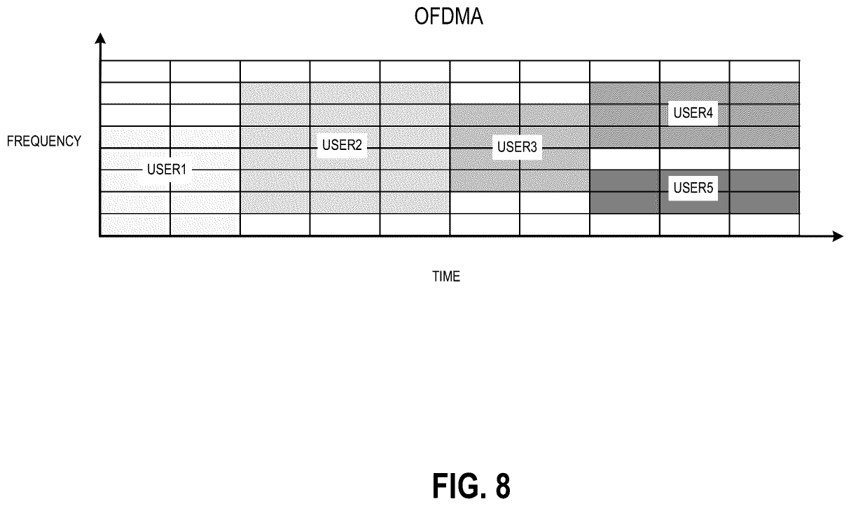

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

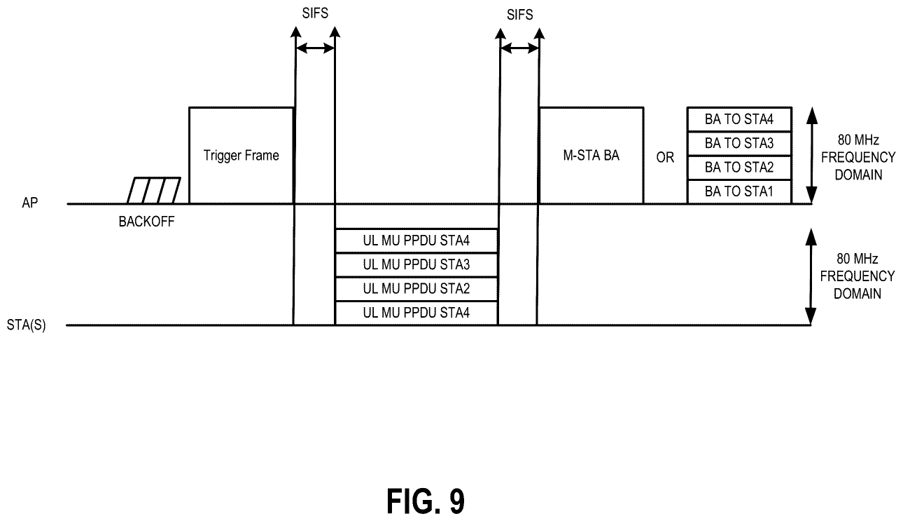

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

A multi-link device (MLD) is a wireless device that supports multi-link operations (MLO). A MLD may communicate with another wireless device on multiple links operating in different channels or frequency bands. A MLD may be classified as a simultaneous transmit and receive (STR) MLD or a non-simultaneous transmit and receive (NSTR) MLD. A STR MLD may be able to transmit and receive data on multiple links simultaneously. A NSTR MLD may only be able to transmit data on multiple links simultaneously or receive data on multiple links simultaneously (the transmission direction must be the same on all links), but not be able to transmit and receive data on multiple links simultaneously.

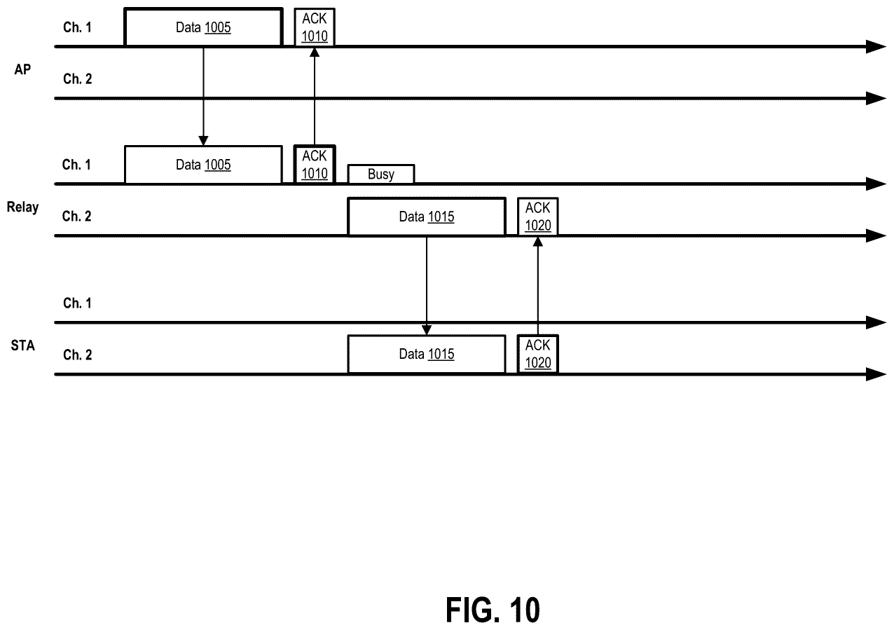

FIG. 10 is a diagram showing DF relay operations with a NSTR MLD relay node, according to some embodiments.

In this and other diagrams, the frames shown with bolded lines represent frames transmitted at the transmitter and frames shown with non-bolded lines that are connected to the frames shown with bolded lines by an arrow represent corresponding frames received at the receiver.

The relay operations shown in this diagram and other diagrams involve an AP, a relay node, and a STA. In the examples shown in the diagrams, the relay node may relay data frames transmitted by the AP to the STA. Thus, in these examples, the AP functions as a source node and the STA functions as a destination node. It should be appreciated, however, that the transmission directions can be reversed, in which case the STA functions as a source node and the AP functions as a destination node.

In this example shown in FIG. 10, it is assumed that the relay node is a MLD that does not support simultaneous transmission and reception. That is, the relay node is a NSTR MLD. The AP and the relay node may communicate with each other on a first link that operates in a first channel (“Ch. 1”). The relay node and the STA may communicate with each other on a second link that operates in a second channel (“Ch. 2”).

As shown in the diagram, the AP may transmit data frame 1005 that includes data intended for the destination node to the relay node on the first link. The relay node may decode data frame 1005 and transmit ACK frame 1010 to the AP on the first link to acknowledge successful reception of data frame 1005. The relay node may then re-encode data frame 1005 as data frame 1015 and transmit (re-encoded) data frame 1015 to the STA on the second link. The STA may decode data frame 1015 and transmit ACK frame 1020 to the relay node on the second link to acknowledge successful reception of data frame 1015.

With these NSTR DF relay operations, the data delivery latency (to deliver data from the AP to the STA) is approximately double (2x) the data delivery latency of a normal data transmission without relay operations due to the relay node having to receive and decode all of data frame 1005 before being able to relay it to the STA. To reduce the data delivery latency, a STR MLD relay node can be used.

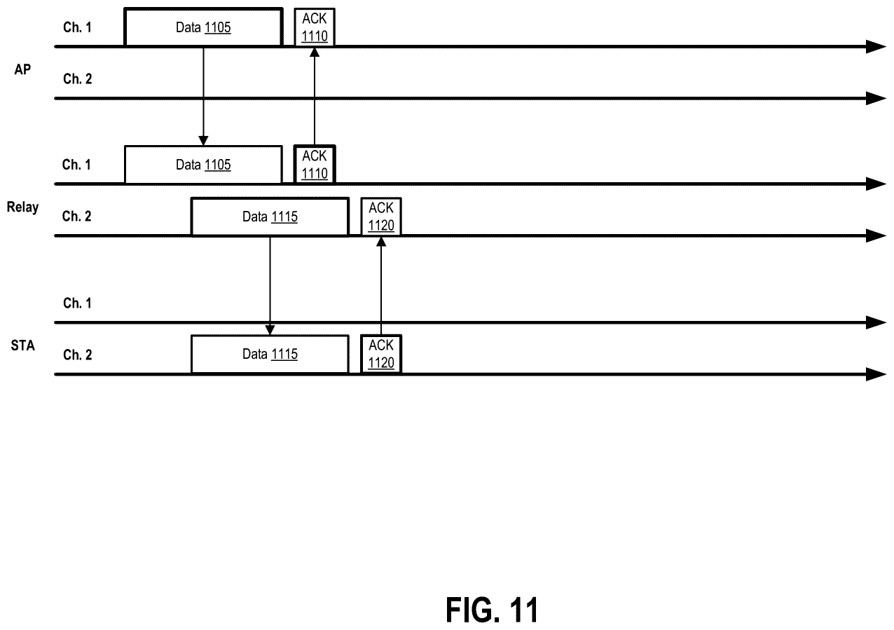

FIG. 11 is a diagram showing DF relay operations with a STR MLD relay node, according to some embodiments.

In the example shown in the diagram, it is assumed that the relay node is a MLD that supports simultaneous transmission and reception. That is, the relay node is a STR MLD. The AP and the relay node may communicate with each other on a first link that operates in a first channel (“Ch. 1”). The relay node and the STA may communicate with each other on a second link that operates in a second channel (“Ch. 2”).

As shown in the diagram, the AP may transmit data frame 1105 that includes data intended for the destination node to the relay node on the first link. While receiving and decoding data frame 1105, the relay node may re-encode the received portions of data frame 1105 as data frame 1115 and transmit (re-encoded) data frame 1115 to the STA on the second link. Thus, the relay node may start transmitting (re-encoded) data frame 1115 to the STA on the second link while the relay node is still receiving (original) data frame 1105 from the AP on the first link (since the relay node is a STR MLD). Once the relay node finishes receiving data frame 1105 on the first link, the relay node may transmit ACK frame 1110 to the AP on the first link to acknowledge successful reception of data frame 1105. Also, once the STA finishes receiving data frame 1115 on the second link, the STA may transmit ACK frame 1120 to the AP on the second link to acknowledge successful reception of data frame 1115.

With these STR DF relay operations, since the relay node is a STR MLD, the relay node may start relaying data frame 1105 to the STA on the second link before finishing reception of data frame 1105 on the first link. Therefore, the data delivery latency can be reduced. However, the delay/latency attributed to the decoding and re-encoding process cannot be reduced (e.g., because the relay node must decode and re-encode at least a portion of data frame 1105 before the relay node can start relaying it to the STA).

According to some embodiments, to further reduce the data delivery latency, a STR MLD relay node may use an AF relay mechanism that is enabled by multi-link operations (i.e., use a MLD AF relay mechanism). An AF relay mechanism does not require a decoding and re-encoding process, which allows the data delivery latency to be further reduced.

In an embodiment, new control frames and a new frame exchange sequence are used to set up the relay link and manage MLD AF relay operations.

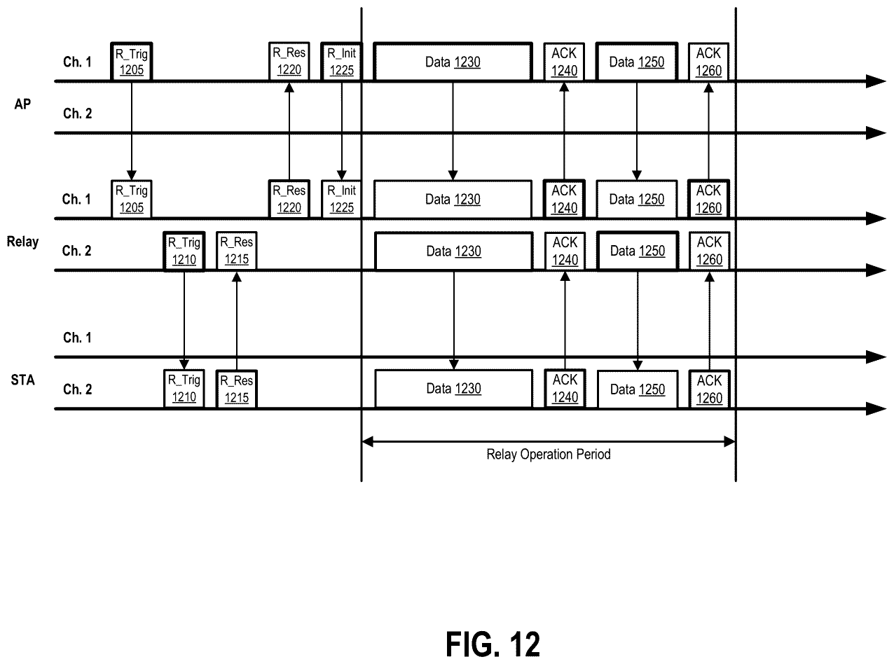

FIG. 12 is a diagram showing MLD AF relay operations with a STR MLD relay node, according to some embodiments.

In the example shown in the diagram, it is assumed that the relay node is a MLD that supports simultaneous transmission and reception. That is, the relay node is a STR MLD.

As shown in the diagram, the AP may transmit a relay trigger frame (“R_Trig”) 1205 to the relay node on a first link between the AP and the relay node. In an embodiment, relay trigger frame 1205 includes information regarding the source node (e.g., the AP), the relay node, and/or the destination node (e.g., the STA) that are to be involved in the relay operations. For example, if the AP decides the relay node and the destination node that are to be involved in MLD AF relay operations, relay trigger frame 1205 may include the address of the source node, the address of the relay node, and the address of the destination node. In an embodiment, the AP only decides the destination node that is to be involved in MLD AF relay operations and allows any device to be the relay node (e.g., devices can volunteer to be the relay node). In this case, the address of the relay node in relay trigger frame 1205 may be set to a value that indicates any device can be the relay node. In an embodiment, the AP decides the relay node that is to be involved in MLD AF relay operations and relay node decides the destination for the MLD AF relay operations. In this case, the address of the destination node in relay trigger frame 1205 may be set to a value that indicates any device can be the destination node. If there are more than two links in the multi-link, relay trigger frame 1205 may include information regarding the link that is to be used for MLD AF relay operations. Thus, the information included in relay trigger frame 1205 may vary depending on the operation scenario.

The first link may operate in a first channel (“Ch. 1”). Responsive to receiving relay trigger frame 1205, the relay node may transmit relay trigger frame 1210 to the STA on a second link between the relay node and the STA to inform the STA that the relay node will be relaying data transmitted by the AP to the STA. The second link may operate in a second channel (“Ch. 2”) that is different from the first channel. Responsive to receiving relay trigger frame 1210, the STA may transmit relay response frame (“R_Res”) 1215 to the relay node on the second link. Responsive to receiving relay response frame 1215, the relay node may transmit relay response frame 1220 to the AP on the first link to confirm to the AP that to the relay node can act as a relay between the source node and the destination node. The exchange of relay trigger frames and relay response frames may set up the relay link, which consists of the first link between the AP and the relay node and the second link between the relay node and the STA. In an embodiment, a relay response frame includes information confirming the relay operations. In an embodiment, relay response frame 1215 (transmitted by the STA) includes information regarding the channel quality (e.g., a signal-to-noise ratio (SNR)) of the second link (between the relay node and the STA) as estimated by the STA. The STA may estimate the channel quality of the second link based on relay trigger frame 1210 using any suitable channel quality estimation technique. In an embodiment, relay response frame 1220 (transmitted by the relay node) includes information regarding the channel quality of the first link (between the AP and the relay node) as estimated by the relay node, as well as information regarding the channel quality of the second link (e.g., which was included in relay response frame 1215 received from the STA). The relay node may estimate the channel quality of the first link based on relay trigger frame 1205 using any suitable channel quality estimation technique. Thus, the AP may be able to obtain information regarding the channel qualities of both the first link and the second link from relay response frame 1220.

The AP may then transmit a relay initiation frame (“R_Init”) 1225 to the relay node to start a relay operation period. The relay initiation frame 1225 may include information regarding the relay operation period such as when the relay operation period starts, the number of frames that are to be relayed during the relay operation period, the transmission direction of the frames that are to be relayed during the relay operation period, and/or the time duration of the relay operation period (e.g., expressed in terms of a number of slots). In an embodiment, the relay operation period starts immediately after the AP transmits the relay initiation frame 1225 or a predefined/prespecified time after the AP transmits relay initiation frame 1225. During the relay operation period, the first link and the second link may be reserved for relay operations.

During the relay operation period, the relay node may perform MLD AF relay operations, as will be described in additional detail herein below. The manner in which the relay node relays frames using the MLD AF relay mechanism during the relay operation period may depend on the transmission direction (e.g., downlink or uplink) of the frames (as mentioned above, information regarding the number of frames that are to be relayed during the relay operation period and the transmission direction of those frames may be included in relay initiation frame 1225). For example, for a frame that is to be relayed in the downlink direction, the relay node may receive the frame from the AP on the first link, frequency shift the frame (from the first channel to the second channel), amplify the data frame, and transmit the data frame to the STA on the second link. Similarly, for a frame that is to be relayed in the uplink direction, the relay node may receive the frame from the STA on the second link, frequency shift the frame (from the second channel to the first channel), amplify the data frame, and transmit the data frame to the AP on the first link. In an embodiment, the relay initiation frame does not include information regarding the number of frames that are to be relayed during the relay operation period and information regarding the transmission direction. In such an embodiment, the relay node may sense both links to detect when any frames are received on those links and when a frame is detected on a link, the relay node may relay the frame on the other link using an AF relay mechanism.

As shown in the diagram, during the relay operation period, the AP may transmit data frame 1230 that includes data intended for the STA on the first link. In an embodiment, the AP determines a modulation coding scheme (MCS) to use for transmitting data frames during the relay operation period based on the information regarding the channel quality of the first link and/or the information regarding the channel quality of the second link (e.g., which the AP may have obtained from relay response frame 1220 received from the relay node). The AP may then transmit data frames that are to be relayed during the relay operation period (e.g., data frame 1230 and data frame 1250) using the determined MCS. Responsive to receiving data frame 1230 on the first link, the relay node may relay data frame 1230 to the STA on the second link using an AF relay mechanism. For example, the relay node may frequency shift data frame 1230 received on the first link (from the first channel to the second channel), amplify it, and transmit it on the second link. It is noted that with the AF relay mechanism, the relay node does not need to decode and re-encode frames before they can be relayed, which reduces the data delivery latency. Responsive to receiving data frame 1230 on the second link, the STA may transmit ACK frame 1240 on the second link to acknowledge successful reception of data frame 1230. Responsive to receiving ACK frame 1240 on the second link, the relay node may relay ACK frame 1240 to the AP on the first link using the AF relay mechanism (e.g., by frequency shifting ACK frame 1240, amplifying it, and transmitting it on the first link). Also, as shown in the diagram, the AP may transmit another data frame 1250 that includes further data intended for the STA on the first link during the relay operation period. Responsive to receiving data frame 1250 on the first link, the relay node may relay data frame 1250 to the STA on the second link using the AF relay mechanism. Responsive to receiving data frame 1250 on the second link, the STA may transmit ACK frame 1260 on the second link to acknowledge successful reception of data frame 1250. Responsive to receiving ACK frame 1260 on the second link, the relay node may relay ACK frame 1240 to the AP on the first link using the AF relay mechanism. In an embodiment, the relay node does not relay frames once the relay operation period ends. In this way, the relay node may relay frames during the relay operation period using a MLD AF relay technique.

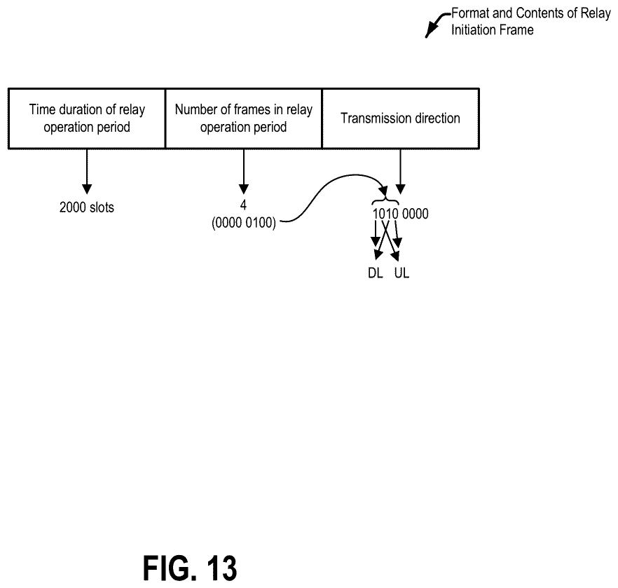

FIG. 13 is a diagram showing the format and contents of a relay initiation frame, according to some embodiments.

As shown in the diagram, the relay initiation frame may include a field (“Relay operation period” field) for indicating information regarding the time duration of a relay operation period, a field (“Number of frames in relay operation period” field) for indicating the number of frames that are to be relayed during the relay operation period, and a field (“Transmission direction” field) for indicating the transmission direction of the frames. While a particular field format for a relay initiation frame is shown in the diagram, it should be appreciated that the relay initiation frame can have a different field format in some embodiments (e.g., the relay initiation frame may include other fields and/or have a different arrangement of fields). Thus, the frame format shown in the diagram should be regarded as being illustrative (i.e., it is just an example) rather than limiting. In this example, the “Relay operation period field” indicates that the time duration of the relay operation period is 2000 slots, the “Number of frames in relay operation period” field indicates that the number of frames that are to be relayed during the relay operation period is four, and the “Transmission direction” field indicates that the first frame is a downlink frame, the second frame is an uplink frame, the third frame is a downlink frame, and the fourth frame is an uplink frame. In the example shown in the diagram, the transmission direction information is encoded using multiple transmission direction bits with each transmission direction bit indicating the transmission direction of one of the frames (e.g., the first transmission direction bit indicates the transmission direction of the first frame, the second transmission direction bit indicates the transmission direction of the second frame, and so forth). The transmission direction bit for a frame being set to “1” may indicate that the frame is a downlink frame, whereas the transmission direction for a frame being set to “0” may indicate that the frame is an uplink frame (although, the opposite convention can be used in some embodiments). Also, in the example shown in the diagram, the transmission direction information is encoded using one byte (8 bits), which allows for encoding the transmission direction for eight frames. If there are more than eight frames to be relayed during the relay operation period, the transmission direction information may be encoded using more than one byte. Thus, the length of the “Transmission direction” field may be variable and depend on the number of frames that are to be relayed during the relay operation period.

In the example shown in the diagram, it is assumed that the relay node is a STR MLD that supports two links. If the relay node is a STR MLD that supports more than two links, the transmission direction information for each frame may be encoded using multiple bits. For example, the AP may communicate with a first STA (STA1) and a second STA (STA2) via a single relay node. There may be three links in this scenario: (1) a first link (link1) between the AP and the relay node; (2) a second link (link2) between the relay node and STA1; and (3) a third link (link3) between the relay node and STA3. There may be four possible combinations of transmission directions on link2 and link3: (1) link2 is uplink and link3 is uplink; (2) link2 is uplink and link3 is downlink; (3) link2 is downlink and link3 is uplink; and (4) link2 is downlink and link3 is downlink. Here, uplink refers to the direction going from a STA to the relay node, whereas downlink refers to the direction going from the relay node to a STA. Two bits may be used to encode the four possible combinations of transmission directions (e.g., the first case is encoded as “00”, the second case is encoded as “01”, the third case is encoded as “10”, and the fourth case is encoded as “11”).

In the example shown in FIG. 12, the AP transmits a relay initiation frame and controls the relay operations. It should be appreciated, however, that the STA can be the one that transmits the relay initiation frame (to perform uplink transmissions during the relay operation period) and control the relay operations. In an embodiment, during the relay operation period, the AP transmits a trigger frame on the first link (that is to relayed by the relay node to the STA on the second link) to solicit an uplink transmission from the STA.

The control frames and frame exchange sequences described herein may allow for proper functioning of MLD AF relay operations. The use of MLD AF relay operations may increase the communication range and network coverage without significantly increasing the data delivery latency.

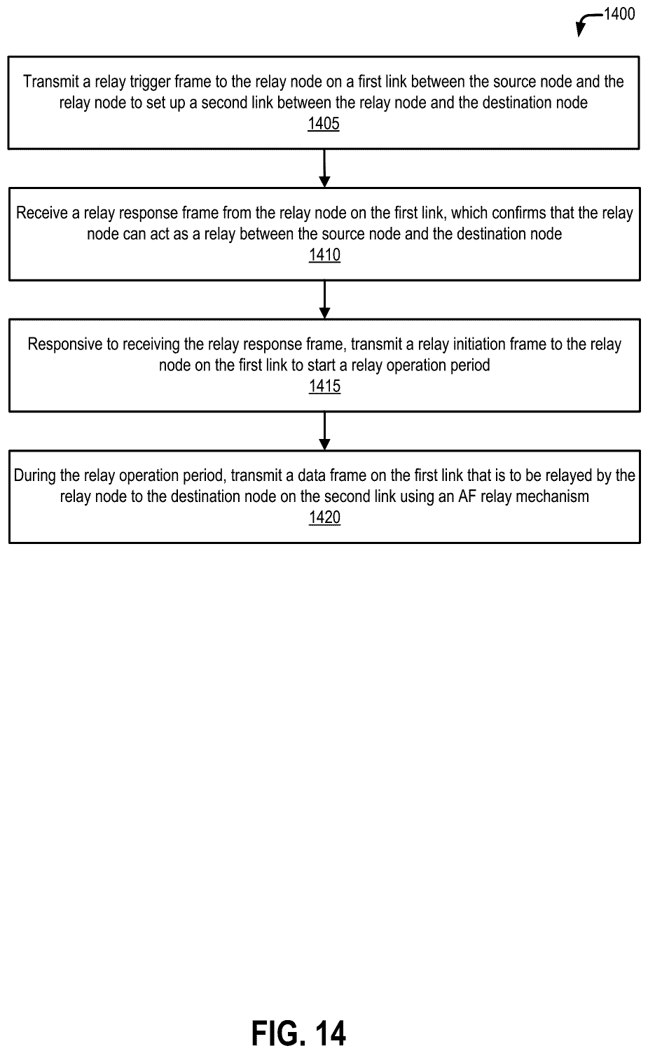

Turning now to FIG. 14, a method 1400 will be described for transmitting data that is to be relayed by a relay node to a destination node using a MLD AF relay mechanism, in accordance with an example embodiment. The method 1400 may be performed by a source node that is to transmit data that is to be relayed by a relay node to a destination node using a MLD AF relay mechanism. The source node may be a wireless device (e.g., wireless device 104).

Additionally, although shown in a particular order, in some embodiments the operations of the method 1400 (and the other methods shown in the other figures) may be performed in a different order. For example, although the operations of the method 1400 are shown in a sequential order, some of the operations may be performed in partially or entirely overlapping time periods.

At operation 1405, the source node transmits a relay trigger frame to the relay node on a first link between the source node and the relay node to set up a second link between the relay node and the destination node. In an embodiment, the relay trigger frame includes information regarding the source node, the relay node, and/or the destination node. The first link and the second link may operate in different channels.

At operation 1410, the source node receives a relay response frame from the relay node on the first link, which confirms that the relay node can act as a relay between the source node and the destination node.

At operation 1415, responsive to receiving the relay response frame, the source node transmits a relay initiation frame to the relay node on the first link to start a relay operation period. In an embodiment, the relay initiation frame includes information regarding a time duration of the relay operation period. In an embodiment, the information regarding the time duration of the relay operation period is expressed in terms of a number of slots. In an embodiment, the relay initiation frame includes information regarding a number of frames that are to be relayed during the relay operation period and information regarding transmission directions of the frames that are to be relayed during the relay operation period. In an embodiment, the relay initiation frame includes a plurality of transmission direction bits, wherein each of the plurality of transmission direction bits indicates a transmission direction for a different one of the frames that are to be relayed during the relay operation period.

At operation 1420, during the relay operation period, the source node transmits a data frame on the first link that is to be relayed by the relay node to the destination node on the second link using an AF relay mechanism. In an embodiment, the relay response frame includes information regarding a channel quality of the first link as estimated by the relay node and information regarding a channel quality of the second link as estimated by the destination node. The source node may determine a MCS to use for transmitting the data frame based on the information regarding the channel quality of the first link and/or the information regarding the channel quality of the second link (and transmit the data frame using the determined MCS).

In an embodiment, during the relay operation period, the source node transmits a trigger frame on the first link that is to be relayed by the relay node to the destination node on the second link to cause the destination node to transmit a frame to the source node

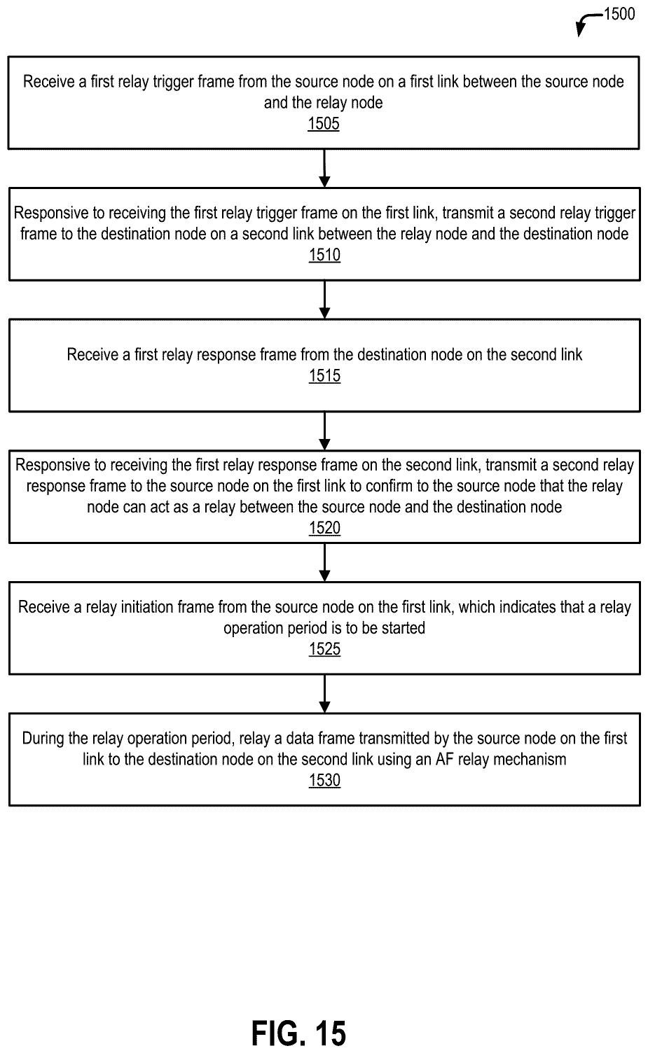

Turning now to FIG. 15, a method 1500 will be described for relaying data transmitted by a source node to a destination node using a MLD AF relay mechanism, in accordance with an example embodiment. The method 1500 may be performed by a relay node that is to relay data transmitted by a source node to a destination node using an AF relay mechanism. The relay node may be a wireless device (e.g., wireless device 104).

At operation 1505, the relay node receives a first relay trigger frame from the source node on a first link between the source node and the relay node. In an embodiment, the first relay trigger frame includes information regarding the source node, the relay node, and/or the destination node.

At operation 1510, responsive to receiving the first relay trigger frame on the first link, the relay node transmits a second relay trigger frame to the destination node on a second link between the relay node and the destination node. The first link and the second link may operate in different channels.

At operation 1515, the relay node receives a first relay response frame from the destination node on the second link. In an embodiment, the first relay response frame includes information regarding a channel quality of the second link as estimated by the destination node.

At operation 1520, responsive to receiving the first relay response frame on the second link, the relay node transmits a second relay response frame to the source node on the first link to confirm to the source node that the relay node can act as a relay between the source node and the destination node. In an embodiment, the relay node estimates a channel quality of the first link based on the first relay trigger frame, wherein information regarding the channel quality of the first link and the information regarding the channel quality of the second link (e.g., which was obtained from the first relay response frame received from the destination node) are included in the second relay response frame.

At operation 1525, the relay node receives a relay initiation frame from the source node on the first link, which indicates that a relay operation period is to be started. In an embodiment, the relay initiation frame includes information regarding a time duration of the relay operation period. In an embodiment, the information regarding the time duration of the relay operation period is expressed in terms of a number of slots. The relay node may determine when the relay operation period ends based on the information regarding the time duration of the relay operation period and stop relaying frames (e.g., turn off its relay functionality off) when the relay operation period ends. In an embodiment, the relay initiation frame includes information regarding a number of frames that are to be relayed during the relay operation period and information regarding transmission directions of the frames that are to be relayed during the relay operation period, wherein the relay node relays frames during the relay operation period based on the information regarding the number of frames that are to be relayed during the relay operation period and the information regarding transmission directions of the frames that are to be relayed during the relay operation period. In an embodiment, the relay initiation frame includes a plurality of transmission direction bits, wherein each of the plurality of transmission direction bits indicates a transmission direction for a different one of the frames that are to be relayed during the relay operation period.

At operation 1530, during the relay operation period, the relay node relays a data frame transmitted by the source node on the first link to the destination node on the second link using an AF relay mechanism.

In an embodiment, the relay node senses the first link to detect frames received on the first link. Responsive to detecting a first frame that is received on the first link, the relay node may relay the first frame on the second link using the AF relay mechanism. In an embodiment, the relay node senses the second link to detect frames received on the second link. Responsive to detecting a second frame that is received on the second link, the relay node may relay the second frame on the first link using the AF relay mechanism.

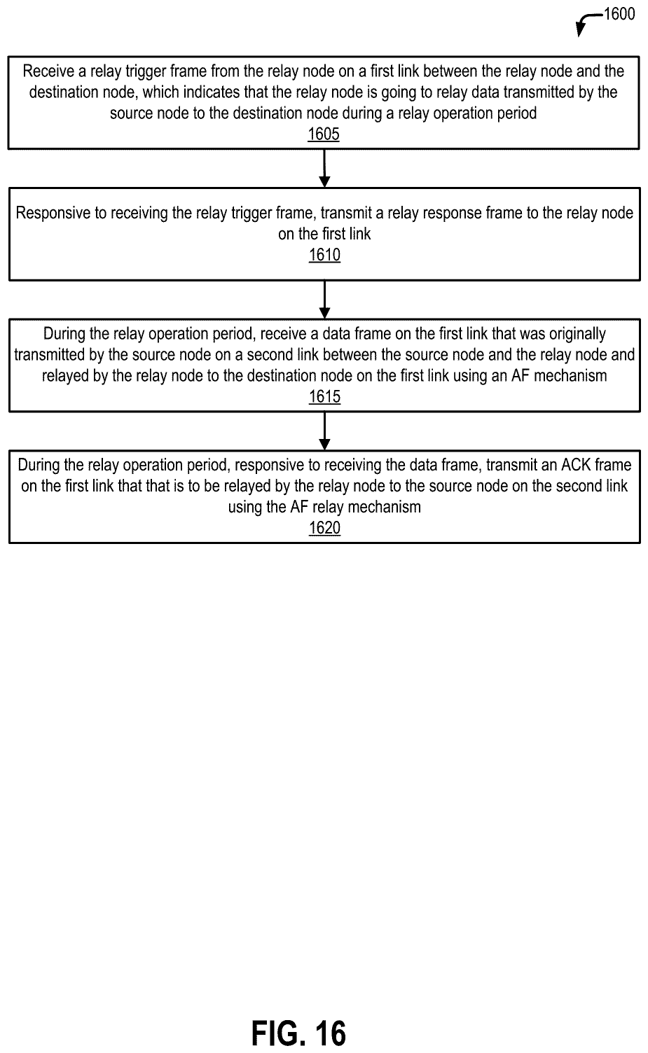

Turning now to FIG. 16, a method 1600 will be described for receiving data transmitted by a source node that was relayed by a relay node using a MLD AF relay mechanism, in accordance with an example embodiment. The method 1600 may be performed by a destination node that is to receive data transmitted by a source node that was relayed by a relay node to the destination node using a MLD AF relay mechanism. The destination node may be a wireless device (e.g., wireless device 104).

At operation 1605, the destination node receives a relay trigger frame from the relay node on a first link between the relay node and the destination node, which indicates that the relay node is going to relay data transmitted by the source node to the destination node during a relay operation period.

At operation 1610, responsive to receiving the relay trigger frame, the destination node transmits a relay response frame to the relay node on the first link. In an embodiment, the destination node estimates a channel quality of the first link based on the relay trigger frame, wherein information regarding the channel quality of the first link is included in the relay response frame.

At operation 1615, during the relay operation period, the destination node receives a data frame on the first link that was originally transmitted by the source node on a second link between the source node and the relay node and relayed by the relay node to the destination node on the first link using an AF mechanism. The first link and the second link may operate in different channels.

At operation 1620, during the relay operation period, responsive to receiving the data frame, the destination node transmits an ACK frame on the first link that that is to be relayed by the relay node to the source node on the second link using the AF relay mechanism.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a source node to transmit data that is to be relayed by a relay node to a destination node using a multi-link device (MLD) amplify-and-forward (AF) relay mechanism, the method comprising:
transmitting a relay trigger frame to the relay node on a first link between the source node and the relay node to set up a second link between the relay node and the destination node;
receiving a relay response frame from the relay node on the first link, which confirms that the relay node can act as a relay between the source node and the destination node;
responsive to receiving the relay response frame, transmitting a relay initiation frame to the relay node on the first link to start a relay operation period; and
during the relay operation period, transmitting a data frame on the first link that is to be relayed by the relay node to the destination node on the second link using an AF relay mechanism.

2. The method of claim 1, wherein the relay trigger frame includes information regarding the source node, the relay node, and the destination node.

3. The method of claim 1, wherein the relay initiation frame includes information regarding a time duration of the relay operation period.

4. The method of claim 3, wherein the information regarding the time duration of the relay operation period is expressed in terms of a number of slots.

5. The method of claim 3, wherein the relay initiation frame further includes information regarding a number of frames that are to be relayed during the relay operation period and information regarding transmission directions of the frames that are to be relayed during the relay operation period.

6. The method of claim 5, wherein the relay initiation frame includes a plurality of transmission direction bits, wherein each of the plurality of transmission direction bits indicates a transmission direction for a different one of the frames that are to be relayed during the relay operation period.

7. The method of claim 1, wherein the relay response frame includes information regarding a channel quality of the first link as estimated by the relay node and information regarding a channel quality of the second link as estimated by the destination node.

8. The method of claim 7, further comprising:
determining a modulation coding scheme (MCS) to use for transmitting the data frame based on the information regarding the channel quality of the first link and/or the information regarding the channel quality of the second link.

9. The method of claim 1, further comprising:
during the relay operation period, transmitting a trigger frame on the first link that is to be relayed by the relay node to the destination node on the second link to cause the destination node to transmit a frame to the source node.

10. A method performed by a relay node to relay data transmitted by a source node to a destination node using a multi-link device (MLD) amplify-and-forward (AF) relay mechanism, the method comprising:
receiving a first relay trigger frame from the source node on a first link between the source node and the relay node;
responsive to receiving the first relay trigger frame on the first link, transmitting a second relay trigger frame to the destination node on a second link between the relay node and the destination node;
receiving a first relay response frame from the destination node on the second link;
responsive to receiving the first relay response frame on the second link, transmitting a second relay response frame to the source node on the first link to confirm to the source node that the relay node can act as a relay between the source node and the destination node;
receiving a relay initiation frame from the source node on the first link, which indicates that a relay operation period is to be started; and
during the relay operation period, relaying a data frame transmitted by the source node on the first link to the destination node on the second link using an AF relay mechanism.

11. The method of claim 10, wherein the first relay trigger frame includes information regarding the source node, the relay node, and the destination node.

12. The method of claim 10, wherein the relay initiation frame includes information regarding a time duration of the relay operation period.

13. The method of claim 12, wherein the information regarding the time duration of the relay operation period is expressed in terms of a number of slots.

14. The method of claim 12, where the relay initiation frame further includes information regarding a number of frames that are to be relayed during the relay operation period and information regarding transmission directions of the frames that are to be relayed during the relay operation period, wherein the relay node relays frames during the relay operation period based on the information regarding the number of frames that are to be relayed during the relay operation period and the information regarding transmission directions of the frames that are to be relayed during the relay operation period.

15. The method of claim 14, wherein the relay initiation frame includes a plurality of transmission direction bits, wherein each of the plurality of transmission direction bits indicates a transmission direction for a different one of the frames that are to be relayed during the relay operation period.

16. The method of claim 10, wherein the first relay response frame includes information regarding a channel quality of the second link as estimated by the destination node.

17. The method of claim 16, further comprising:
estimating a channel quality of the first link based on the first relay trigger frame, wherein information regarding the channel quality of the first link and the information regarding the channel quality of the second link are included in the second relay response frame.

18. The method of claim 10, further comprising:
sensing the first link to detect frames received on the first link;
responsive to detecting a first frame that is received on the first link, relaying the first frame on the second link using the AF relay mechanism;
sensing the second link to detect frames received on the second link; and
responsive to detecting a second frame that is received on the second link, relaying the second frame on the first link using the AF relay mechanism.

19. A wireless device to implement a source node that is to transmit data that is to be relayed by a relay node to a destination node using a multi-link device (MLD) amplify-and-forward (AF) relay mechanism, the wireless device comprising:
a radio frequency transceiver;
a memory device storing a set of instructions; and
a processor coupled to the memory device, wherein the set of instructions, when executed by the processor, causes the source node to:
transmit a relay trigger frame to the relay node on a first link between the source node and the relay node to set up a second link between the relay node and the destination node;
receive a relay response frame from the relay node on the first link, which confirms that the relay node can act as a relay between the source node and the destination node;
responsive to receiving the relay response frame, transmit a relay initiation frame to the relay node on the first link to start a relay operation period; and
during the relay operation period, transmit a data frame on the first link that is to be relayed by the relay node to the destination node on the second link using an AF relay mechanism.

20. The wireless device of claim 19, wherein the relay initiation frame includes information regarding a time duration of the relay operation period, information regarding a number of frames that are to be relayed during the relay operation period, and information regarding transmission directions of the frames that are to be relayed during the relay operation period.
